(19) United States
(12) Patent Application Publication
(10) Pub. No.: US 2013/0319288 A1
(43) Pub. Date: Dec. 5, 2013

(54) Environmentally Friendly Medical Packaging

(71) Applicants: Nadya Belcheva, Hamden, CT (US); David Kirsch, Madison, CT (US); Ahmad Robert Hadba, Middlefield, CT (US)

(72) Inventors: Nadya Belcheva, Hamden, CT (US); David Kirsch, Madison, CT (US); Ahmad Robert Hadba, Middlefield, CT (US)

(21) Appl. No.: 13/487,663

(22) Filed: Jun. 4, 2012

(51) Int. Cl. C08K 5/092; C08G 63/91; C08G 63/02; C08G 63/08; C08G 63/00; C08K 3/08; C08B 1/00; C08L 67/04; C08L 29/04; C08L 67/02; C08L 3/00; C08L 1/00; C08G 63/06; C08B 31/00

(52) U.S. Cl. 106/163.01; 528/361; 525/56; 528/272; 528/354; 528/271; 536/102; 536/56; 524/599; 524/557; 524/601; 106/206.1; 524/439; 525/450; 525/437; 524/321

(57) ABSTRACT

Packaging materials for medical devices are provided. The packaging is formed of a biodegradable material which permits disposal by conventional methods, including landfills, composting, and the like. Use of the packaging avoids undesirable disposal methods such as incineration and the like.

### TECHNICAL FIELD

The present disclosure relates to packaging materials suitable for packaging medical devices. The packaging materials are formed of biodegradable/biocompostable materials, and are thus environmentally friendly.

### DESCRIPTION OF RELATED ART

Biodegradable/biocompostable plastics and polymers have been developed. These polymers can be degraded into low molecular weight compounds in a relatively short period of time by enzymes produced by microorganisms found in the environment, including bacteria, fungi and/or algae. Biodegradable/biocompostable plastics are eventually degraded to small inorganic molecules, such as carbon dioxide and water.

Medical instruments and supplies, such as syringes, surgical tubing, catheters, test tubes, collection bags, sutures, staplers, components thereof, as well as packaging for these items, have traditionally been made with petroleum-based polymers. While these polymers are extremely durable, their disposal can be hazardous to the environment, as the polymers and/or their by-products may be toxic. Moreover, these polymers may require undesirable means for disposal, including incineration/burning. Some of these polymers are non-biodegradable/non-biocompostable and can persist for many years in the environment. Furthermore, such materials are often soiled by biological substances, making recycling of these materials difficult.

Improved materials for forming medical devices, as well as packaging for such devices, remain desirable.

### SUMMARY

The present disclosure provides for packaging suitable for medical devices, and medical devices packaged with such packaging. In embodiments, packaging for a medical device in accordance with the present disclosure includes at least one hydrolytically degradable or compostable polymer such as polylactic acid, polyhydroxybutyrate, polyvinyl alcohol, polybutylene succinate, polyhydroxyalkanoates, polycaprolactones, copolyesters, aliphatic-aromatic copolyesters, starches, celluloses, biopolymers, and combinations thereof, wherein at least a portion of the packaging includes the at least one hydrolytically degradable or compostable polymer and the packaging is for a medical device such as test tubes, syringes, tubing, catheters, shunts, collection bags, sutures, staplers, endoscopic devices, hernia meshes, monitoring sensors, pulse oximeters, and combinations thereof.

In other embodiments, packaging for a medical device in accordance with the present disclosure includes at least one hydrolytically degradable or compostable polymer comprising a non-degradable polymer in combination with an additive including a chemo attractant compound; a glutaric acid or its derivative; a carboxylic acid compound having a chain length from about 5 to about 18 carbons; a polymer; and a swelling agent, wherein at least a portion of the packaging includes the at least one hydrolytically degradable or compostable polymer and the packaging is for a medical device such as test tubes, syringes, tubing, catheters, shunts, collection bags, sutures, staplers, endoscopic devices, hernia meshes, monitoring sensors, pulse oximeters, and combinations thereof.

### BRIEF DESCRIPTION OF THE DRAWINGS

FIG. 1A is a perspective view of a suture package according to an embodiment of the present disclosure;

FIG. 1B is a perspective view of a cover for the suture package of FIG. 1A;

FIG. 1C is a perspective view of the suture package of FIG. 1A, including a barbed suture;

FIG. 1D is a perspective view of a suture package according to an embodiment of the present disclosure, including the suture package of FIG. 1A and the cover of FIG. 1B;

FIG. 2 is a perspective view of a surgical instrument package in accordance with the present disclosure, with instruments contained therein;

FIG. 3 is a perspective view of a package formed of a polymer in accordance with the present disclosure, and instruments removed from an outer envelope of such a package; and

FIG. 4 is an exploded perspective view of an alternative package in accordance with the present disclosure, shown in combination with an instrument holding member and a surgical instrument.

### DETAILED DESCRIPTION

The present disclosure provides biodegradable/biocompostable packaging materials suitable for packaging medical devices. By “biodegradable/biocompostable,” it is meant that the material decomposes, or loses structural integrity under environmental conditions (e.g., enzymatic degradation or hydrolysis) or is broken down (physically or chemically) under conditions in the environment. The rate of degradation can vary from several days to several months, depending on the chemical nature of the material. It should be understood that such materials include natural, synthetic, bioabsorbable, and/or certain non-absorbable materials, as well as combinations thereof.

Representative biodegradable/biocompostable polymers which may be used to form the medical device packaging include, but are not limited to, polylactic acid (e.g., BIO-FLEX, available from FKuR Kunststoff GmbH, Germany; ECOLOJU, available from Mitsubishi Plastics, Inc., Japan; HYCAIL, available from Hycail, the Netherlands; INGEO 2002D, available from NatureWorks LLC, Minnetonka, Minn.), polyhydroxybutyrate (e.g., BIOMER L, available from Biomer, Germany), polyvinyl alcohol (e.g., BIOSOL, available from Panteco, Italy; GOHSENOL, available from Nippon Gohsei, Japan; MAVINSOL, available from Panteco, Italy; MOWIOL, available from Kuraray America, Inc., Houston, Tex.; KURARAY POVAL, available from Kuraray America, Inc., Houston, Tex.), polybutylene succinate (e.g., GREEN PLASTICS, available from Mitsubishi, Japan), polyhydroxyalkanoates (e.g., MIREL, available from Telles (Metabolix and Archer Daniels Midland Company), Lowell, Mass.), polycaprolactones (e.g., CAPA, available from Solvay, United Kingdom), copolyesters (e.g., CADENCE, available from Eastman, Kingsport, Tenn.), aliphatic-aromatic copolyesters (e.g., EASTAR, available from Eastman, Kingsport, Tenn.; ECOFLEX, available from BASF, Germany), starches (e.g., BIOPLAST, available from Biotec, Germany; BIOPAR, available from BIOP Biopolymer Technologies AG, Dresden, Germany; CEREPLAST COMPOSTABLES and CEREPLAST HYBRID RESINS, available from Cereplast, Hawthorne, Calif.; COHPOL, available from VTT Chemical Technology, Finland; ECOPLAST, available from Groen Granulaat, the Netherlands; EVERCORN, available from Japan Corn Starch Co., Japan; MATER-BI, available from Novamont, Italy; PLANTIC, available from Plantic Technologies Limited, Victoria, Australia; SOLANYL, available from Rodenburg Polymers, the Netherlands; SORONA, available from DuPont, Wilmington, Del.; RE-NEW 400, available from StarchTech, Golden Valley, Minn.; TERRATEK, available from MGP Ingredients, Atchison, Kans.; VEGEMAT, available from Vegeplast, France), celluloses (e.g., BIOGRADE, available from FKuR Kunststoff GmbH, Germany), other biopolymers (e.g., LUNARE SE, available from Nippon Shokubai, Japan), and combinations thereof.

In other embodiments, conventional polymers may be converted to degradable materials. For example, in embodiments, commodity plastics such as polystyrene, polyethylene, polypropylene, polyvinyl chloride (PVC), combinations thereof, and the like, may be treated so that they become biodegradable. Methods of treating such materials include, for example, the inclusion of chemical additives to make the polymeric material biodegradable. One suitable additive is the ECOPURE® additive, commercially available from Bio-Tec Environmental of Albuquerque, N.Mex. The ECOPURE additive is physically blended with a polymeric material to create at least a partially biodegradable product. As disclosed in U.S. Patent Application Publication No. 2008/0103232, the entire disclosure of which is incorporated by reference herein, the additives may include, in combination, a chemo attractant compound; a glutaric acid or its derivative; a carboxylic acid compound having a chain length from 5-18 carbons; a polymer; and a swelling agent. In addition, the additive may also include a microbe which can digest the polymeric material, a compatibilizing additive, a positive chemotaxis agent to attract the microbes, a metal to induce rusting, colorants and/or inks, metallic particles, and/or a carrier resin. Due to the presence of the additive, microbes (including in the composition or present in the environment) sense the hydrocarbons within the polymer chain, turning the plastic products into CO₂ (aerobically), CH₄ (anaerobically), biomass, and water.

Plastics and/or polymers treated with these additives possess the same physical properties as the corresponding plastics and/or polymers that have not been treated with these additives.

In other embodiments, additional or different additives may be combined with plastics and/or polymers used to form the packaging of the present disclosure to alter, in embodiments increase, the mechanical properties of the packaging material. For example, in embodiments, a chain extension agent may be used as an additive in an effective amount to increase the mechanical strength and processability of the polymer used to form the packaging material, compared to the same polymer formed in the absence of the chain extension agent.

Suitable chain extension agents include molecules having two or more reactive functional groups, such as isocyanates, epoxides, anhydrides, acid chlorides, esters, aldehydes, combinations thereof, and the like. In embodiments, a chain extension agent may be present in an amount from about 0.1% to about 5% by weight of a biodegradable plastic or polymer used to form a packaging of the present disclosure, in embodiments from about 0.5% to about 2% by weight of a biodegradable plastic or polymer used to form a packaging of the present disclosure.

In embodiments, the chain extension agent may be a diisocyanate. Suitable diisocyanates include, for example, 6-hexamethylene diisocyanate, 1,4-tertramethylene diisocyanate, ethylene diisocyanate and 1,12-dodecane diisocyanate, 5-isocyanato-1-(isocyanatomethyl)-1,3,3-trimethylcyclohexane, 1,3-bis(1-isocyanato-1-methylethyl)benzene, cyclohexane-1,3-diisocyanate, cyclohexane-1,4-diisocyanate, 4,4′-diisocyanatodicyclohexylmethane, 2,4-diisocyanatodicyclohexylmethane, 1,3phenylene diisocyanate, 1,4-phenylene diisocyanate, and combinations thereof.

In other embodiments, the chain extension agent may possess a vinyl group. Suitable vinyl groups include, for example, acrylates, methacrylates, and combinations thereof.

Without wishing to be bound by any theory, it is believed the above additives affect the molecular structure of the polymer by scissoring the polymer chain and adding nutrients and other organic compounds that promote microbial colonization inside and around the plastic material. These microbes then secrete acids which break down the entire polymer chain. Polymers treated with these additives are thus capable of producing end products having an indefinite shelf life until placed in an active microbial environment, such as a landfill.

Additional additives may be included in forming the packaging materials of the present disclosure. For example, in embodiments, additional additives include microbes which can digest the polymeric material, compatibilizing additives, positive chemotaxis agents to attract microbes to the material once disposed in the environment, metals to induce rusting, colorants, carrier resins, and combinations thereof.

In embodiments, the above additive may be blended with the polymer prior to forming packaging materials therefrom. For example a master batch including pellets of the additive may be added to pellets of the polymer. The pellets are then blended, heated, and used to form a plastic capable of forming packaging for a medical device. Methods for forming the plastic include conventional methods such as extrusion, injection molding, sonic welding, spin welding, combinations thereof, and the like. Methods utilized will depend upon the polymers and/or plastics utilized, any additives, and intended uses of the packaging materials.

In other embodiments, as noted above, at least part of the device and/or packaging may be made of biodegradable/biocompostable materials. Selection of starting materials may be utilized to alter the properties of the material and any packaging formed therefrom, e.g., packaging materials may be clear or opaque, flexible or rigid, and the like.

In embodiments, packaging of the present disclosure may include a clear plastic sheet formed of the biodegradable/biocompostable polymer.

Materials formed of these biodegradable/biocompostable materials may degrade without requiring undesirable treatments, such as incineration/burning. They may degrade in soil and water environments, as well as composting facilities. The rate and extent of degradation may be influenced by the size and shape of any articles formed from these biodegradable materials, in embodiments from a couple months to a couple years, in embodiments from about 3 months to about 3 years, in embodiments from about 6 months to about 2 years, in embodiments from about 12 months to about 18 months.

The biodegradable/biocompostable polymers in accordance with the present disclosure may be used to form packaging for any medical device. Exemplary designs of packaging suitable for use for medical devices includes, for example, the packaging disclosed in U.S. Pat. Nos. 5,699,909, 8,136,656, 5,353,929, and 5,341,922, the entire disclosures of each of which are incorporated by reference herein. Suitable devices include, for example, test tubes, syringes, tubing, catheters, shunts, collection bags, sutures, staplers, endoscopic devices, hernia meshes, monitoring sensors, pulse oximeters, combinations thereof, and the like.

In some embodiments, packaging materials of the present disclosure may include both the biodegradable/biocompostable polymers of the present disclosure and non-biodegradable biocompatible polymers. In yet other embodiments, packaging materials of the present disclosure may include a polymer coating. Such polymer coatings may be formed of the biodegradable/biocompostable polymers described above. In other embodiments, such polymer coatings may be formed of any suitable coating within the purview of one skilled in the art. In embodiments, the coating may be a biodegradable or slowly biodegradable polymer coating.

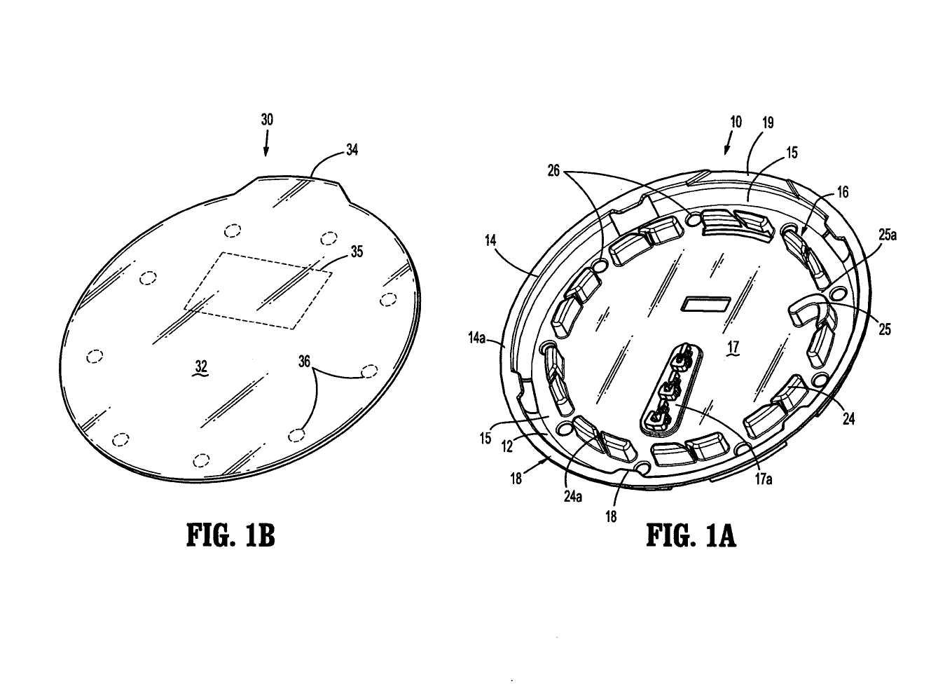

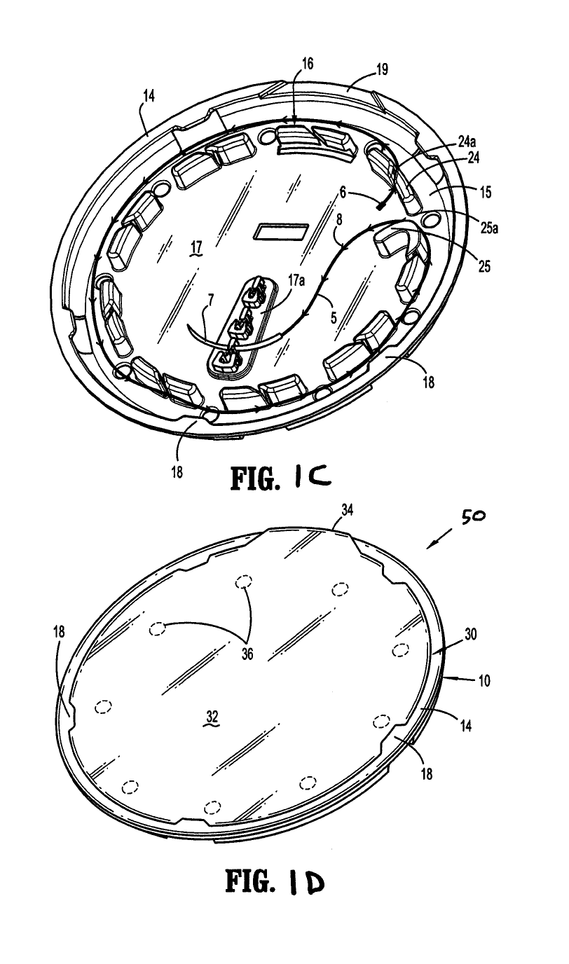

In embodiments, packaging which may be formed from the biodegradable/biocompostable polymers of the present disclosure includes the suture packaging depicted in FIGS. 1A-1D. With reference to FIGS. 1A and 1B, suture package 50 (FIG. 1D) includes a substantially rigid suture retaining member 10 (FIG. 1A) and a cover 30 (FIG. 1B). Suture retaining member 10 may be composed of polymers or other suitable material. Suture retaining member 10 is configured to retain one or more barbed sutures 5 (FIG. 1C). Cover 30 is configured to selectively engage suture retaining member 10, thereby creating a closed suture retaining area 15 for maintaining suture 5 with suture retaining member 10.

With reference to FIG. 1B, cover 30 defines a substantially planar member 32 configured to selectively engage suture retaining member 10. As shown, cover 30 defines a substantially circular configuration; however, cover 30 may be formed to fit a suture retaining member of any configuration, including oval, octagonal and rectangular configurations. Cover 30 may be formed of cardboard, heavy paper, semi-flexible plastic or any other suitable material. Cover 30 includes one or more tabs 34. As will be discussed in further detail below, tab 34 is configured for engagement by a user to facilitate separation of cover 30 from suture retaining member 10.

With reference still to FIG. 1B, cover 30 may also include a cut-out or window 35 (shown in phantom). Cut-out 35 is configured for viewing of indicia located on suture retaining member 10 and/or viewing the contents of suture retaining member 10. Alternatively, or in addition, cut-out 35 may be configured for engagement by a user to facilitate removal of cover 30 from suture retaining member 10. Cover 30 may further include a plurality of openings 36 (shown in phantom) radially spaced about a perimeter of cover 30. As will be discussed in further detail below, openings 36 are aligned with openings 26 formed in suture retaining member 10 and are sized to engage mounting pins (not shown) of a suture loading apparatus (also not shown).

Turning to FIG. 1A, suture retaining member 10 includes a substantially planar base 12, an outer wall 14, and an inner wall 16. Outer wall 14 extends about a perimeter of base 12 to define a first wall of a suture retaining portion 15. Inner wall 16 is spaced radially inward of outer wall 14. Inner wall 16 forms a second wall defining suture retaining portion 15. A needle retaining area 17 is formed interior to inner wall 16. In one embodiment, a needle park 17a is integrally formed with planar base 12. Needle park 17a may be configured to receive one or more suture needles of various sizes and configurations. In an alternative embodiment, needle park 17a may be secured to planar base 12 using adhesive, glue, ultrasonic welding or the like. In another embodiment, suture needle 7 (FIG. 1C) may be loosely received within needle retaining area 17.

With reference still to FIG. 1A, outer wall 14 includes a plurality of inwardly extending tabs 18 formed on a top surface 14a thereof. Tabs 18 are configured to engage cover 30 when cover 30 is received within outer wall 14. A notched or recessed portion 19 is formed on top surface 14a of outer wall 14. As will be discussed in further detail below, recessed portion 19 is configured to receive tab 34 of cover 30 when cover 30 is engaged with tabs 18 of outer wall 14.

Still referring to FIG. 1A, as discussed above, inner wall 16 is radially spaced from outer wall 14 to form suture retaining area 15. The greater the distance of inner wall 16 from outer wall 14, the larger suture retaining area 15. Suture retaining area 15 may be configured to receive one or more sutures 5 (FIG. 1C) Inner wall 16 is formed by a series of spaced protrusions 24. At least one of protrusions 24 includes a slot 24a which, in some embodiments, may be configured to receive distal end 6 of suture 5. At least one of protrusions 24 includes an inwardly curved protrusion 25 configured to form an opening 25a into needle retaining area 17. In this manner, when the body portion of suture 5 is retained within suture retaining area 15, the end of suture 5 including needle 7 may be received through opening 25a such that needle 7 may be received within needle retaining area 17. Protrusions 24 are of sufficient height to support cover 30 when cover 30 is selectively engaged with tabs 18 of outer wall 14 (FIG. 1D). In this manner, when suture 5 is retained within suture retaining area 15, barbs 8 are not flattened by cover 30 when cover 30 is selective engaged with suture retaining member 10.

With reference still to FIG. 1A, suture retaining member 10 further includes a plurality of openings 26 radially spaced about planar base 12. Openings 26 are configured to engage mounting pins (not shown) of a suture loading apparatus (also not shown). Openings 26 may be, as shown, located within the spaces between protrusions 24, or alternatively, openings 26 may be formed in suture retaining area 15 and/or needle retaining area 17.

The loading of a suture 5 within suture package 50 will now be described in detail with reference to FIG. 1C. To facilitate loading of suture 5 within suture retaining member 10, suture retaining member 10 may be received on a suture loading apparatus (not shown). In this manner, suture retaining member 10 is placed on the suture loading apparatus such that mounting pins (not shown) engage openings 26 formed in suture retaining member 10. Initially, the end of suture 5 including end effector 6 is received within slot 24a formed within one of protrusions 24 extending from planar base 12. Alternatively, the end of suture 5 including end effector 6 may be loosely received within suture retaining area 15.

With reference still to FIG. 1C, the body portion of suture 5 is next received within suture retaining area 15. Suture 5 is then wound in around inner wall 16 of suture retaining member 10 to receive suture 5 within suture retaining area 15. Suture 5 may be rotated about inner wall 16 in a clockwise direction, or instead, as shown, in a counter-clockwise direction. Alternatively, suture retaining member 10 may be rotated in a clockwise direction, either manually or through the operation of the suture loading apparatus to wind suture 5 about inner wall 16. The direction suture 5 is wound about inner wall 16 is generally determined by the configuration of curved protrusion 25. Suture 5 is wound in a direction that enables suture 5 to be inserted through opening 25a and wrapped about curved protrusion 25. In this manner, suture 5 is prevented from creasing or folding at needle 7 is received within needle retaining area 17. Suture 5 may be wound about inner wall 16 of suture retaining member 10 one or more times, depending on the length of suture 5.

Still referring to FIG. 1C, the body portion of suture 5 is received within suture retaining area 15, the end portion of suture 5 containing needle 7 is then received through opening 25a formed by curved protrusion 25 such that needle 7 is received within needle retaining area 17. Needle 7 then is then selectively engaged with needle park 17a.

Turning now to FIG. 1D, once suture 5 is received within suture retaining area 15 of suture retaining member 10, cover 30 is placed onto suture retaining member 10. When a suture loading apparatus (not shown) is used, the alignment pins (not shown) extending through openings 26 formed in suture retaining member 10 align tab 34 of cover 30 with recessed portion 19 of suture retaining member 10. Absent the suture loading apparatus, tab 34 of cover 30 must be manually aligned with recessed portion 19 of suture retaining member 10. To secure cover 30 within suture retaining member 10 an outer rim of cover 30 is received under inwardly extending tabs 18 formed on outer wall 14 of suture retaining member 10. In this manner, cover 30 engages a top surface of inner wall 16 to secure suture 5 within suture retaining area 15 and needle 7 within needle retaining area 17. Suture package 50 may then be removed from the suture loading apparatus and hermetically sealed in sterile packaging (not shown).

To remove suture 5 from suture packaging 50, suture packaging 50 is first removed from any packaging in which it might be encased. A clinician next holds suture retaining member 10 in a first hand about outer wall 14 while gripping tab 34 formed on cover 30. The engagement of tab 34 by the clinician is facilitated through the overlap of tab 34 with outer wall 14. Tab 34 of cover 30 is then pulled away from suture retaining member 10 to disengage cover 30 from inwardly extending tabs 18 formed on outer wall 14, thereby separating cover 30 from suture retaining member 10 and exposing suture 5. In an alternate embodiment, the clinician inserts one or more fingers through cut-out 35 in cover 30 to separate cover 30 from suture retaining member 10.

A clinician may then manually grasp needle 7 by hand or with forceps or other grasping instrument, to remove needle 7 from needle park 17a. Continued pulling on needle 7 causes suture 5 to be withdrawn from opening 25a and released from suture retaining portion 15. If the end of suture 5 including end effector 6 is secured within slot 24a of protrusion 24, then the clinician may have to separate suture 5 from suture retaining member 10 manually, otherwise, suture 5 should easily withdraw from suture retaining area 15 without becoming entangled.

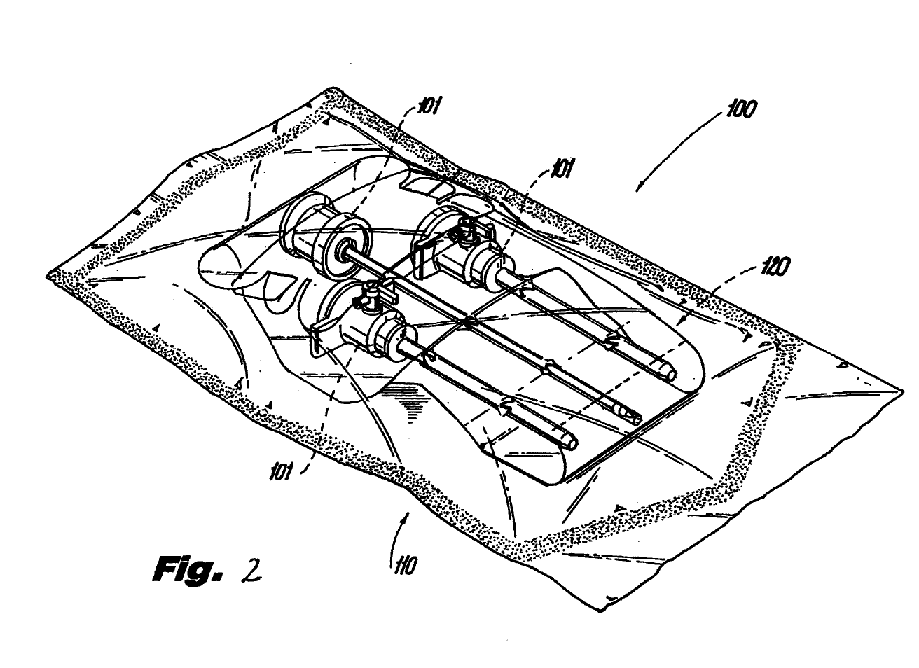

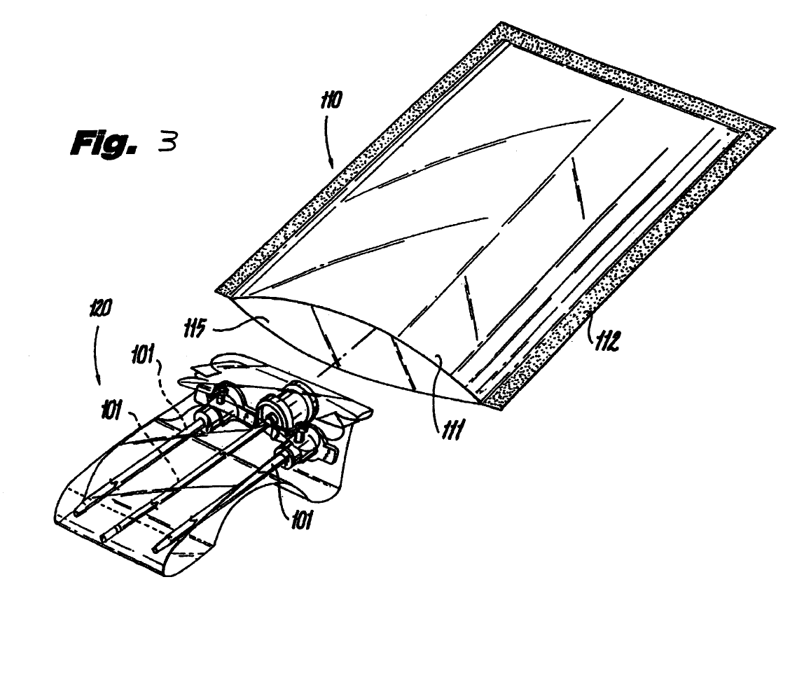

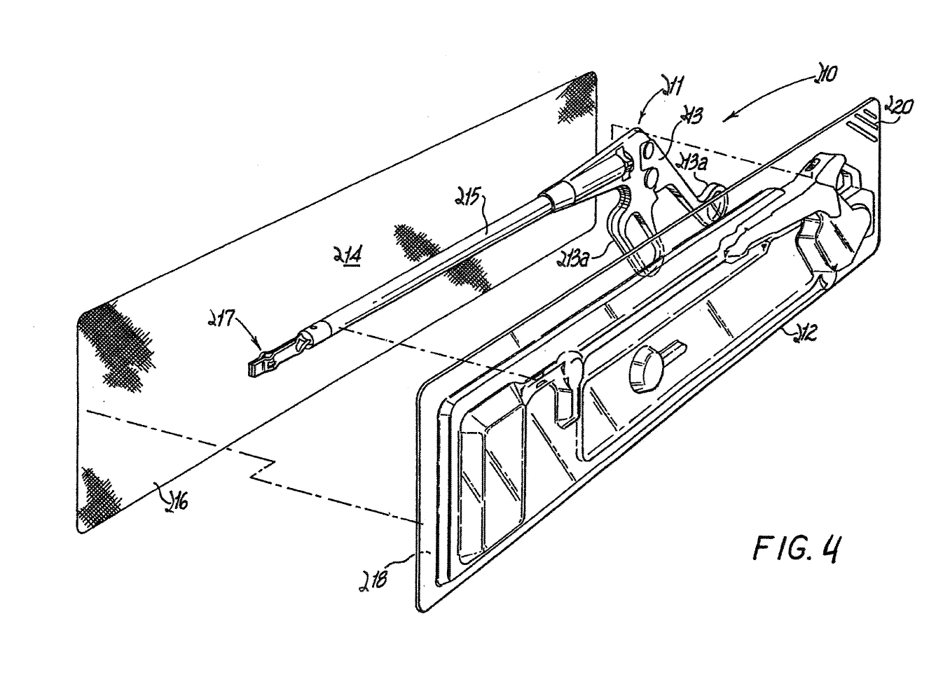

In other embodiments, as illustrated in FIGS. 2 and 3, biodegradable packaging for a medical device may be a package for endoscopic instruments. FIG. 2 illustrates a packaged surgical instrumentation kit 100 having at least one and preferably two or more surgical instruments 101, an outer envelope 110, and a retainer 120 for retaining the instruments 101.

Outer envelope 110 encloses the retainer 120 and surgical instruments 101. The outer envelope 110 is preferably a material impervious to fluids and capable of maintaining a sterile interior. A preferred construction is illustrated in FIG. 3, wherein upper layer 111 is a clear cover bonded around periphery 112 to a lower layer. Bonding is achieved by any of the methods conventionally used in the art, such as heating, adhesives, and the like. The instruments 101 can be any type of instrument having an elongated narrow portion. However, the packaging described in this embodiment is especially advantageous for retaining and enclosing elongated surgical instruments, such as those used in minimally invasive surgical procedures (e.g., laparoscopic or endoscopic surgery).

An alternate biodegradable/biocompostable packaging for medical instruments is depicted in FIG. 4, in which an elongated surgical instrument package 210 for holding an elongated surgical instrument 211 is shown. The elongated instrument includes a handle portion 213, an elongated portion 215, and a working end 217.

The package 210 includes a relatively rigid molded instrument holding member 212 and a peelable or strippable cover member 214, which is capable of maintaining the sterile condition of the package contents. Instrument holding member 212, cover member 214, or both, can be fabricated from the biodegradable polymers of the present disclosure. In the sealed condition of the package, cover member 214 is bonded along its perimeter region 216 to perimeter region 218 of instrument holding member 212 employing any suitable adhesive. The perimeter region 218 of the instrument holding member 212 is formed in a first and uppermost plane of the rigid instrument holding member 212. A knurled section 220 at the proximal end of instrument holding member 212 is not bonded to cover 214 and facilitates gripping of the cover 214. Access to the package is provided by gripping the cover 214 in one hand, holding the knurled section 220 in the other, and pulling back of the cover member 214.

The rigid instrument holding member 212 includes a channel encompassing the handle 213, including the finger ring portions 213a of the handle 213, which prevents the handle 213 from shifting about in the package, preferably through frictional engagement with the handle.

Medical devices and packaging materials in accordance with the present disclosure possessing these medical devices can then be sterilized in accordance with techniques within the purview of those skilled in the art, including conventional means such as ethylene oxide, gamma irradiation, and the like.

It will be understood that various modifications may be made to the embodiments disclosed herein. Therefore, the above description should not be construed as limiting, but merely as an exemplification of illustrative embodiments. Those skilled in the art will envision other modifications within the scope and spirit of the present disclosure. Such modifications and variations are intended to come within the scope of the following claims.

What is claimed is:

1. A packaging for a medical device comprising:
at least one hydrolytically degradable or compostable polymer selected from the group consisting of polylactic acid, polyhydroxybutyrate, polyvinyl alcohol, polybutylene succinate, polyhydroxyalkanoates, polycaprolactones, copolyesters, aliphatic-aromatic copolyesters, starches, celluloses, biopolymers, and combinations thereof,
wherein at least a portion of the packaging comprises the at least one hydrolytically degradable or compostable polymer and the packaging is for a medical device selected from the group consisting of test tubes, syringes, tubing, catheters, shunts, collection bags, sutures, staplers, endoscopic devices, hernia meshes, monitoring sensors, pulse oximeters, and combinations thereof.

2. The packaging of claim 1, further comprising an additive selected from the group consisting of a microbe which can digest the polymeric material, a compatibilizing additive, a positive chemotaxis agent to attract the microbes, a metal to induce rusting, a colorant, a carrier resin, and combinations thereof.

3. The packaging of claim 1, wherein the packaging includes a clear plastic sheet comprising the hydrolytically degradable or compostable polymer.

4. The packaging of claim 1, wherein the hydrolytically degradable or compostable polymer further comprises a chain extension agent in an effective amount to increase the mechanical strength and processability of the polymer compared to the same polymer formed in the absence of the chain extension agent.

5. The packaging of claim 4, wherein the chain extension agent is a molecule having two or more reactive functional groups selected from the group consisting of isocyanates, epoxides, anhydrides, acid chlorides, esters, aldehydes, and combinations thereof.

6. The packaging of claim 4, wherein the chain extension agent comprises a diisocyanate.

7. The packaging of claim 4, wherein the chain extension agent comprises a vinyl group.

8. The packaging of claim 1, further comprising a non-biodegradable biocompatible polymer.

9. The packaging of claim 1, further comprising a polymer coating.

10. The packaging of claim 9, wherein the polymer coating is selected from the group consisting of biodegradable and slowly biodegradable polymer coatings.

11. A packaging for a medical device comprising:
at least one hydrolytically degradable or compostable polymer comprising a non-degradable polymer in combination with an additive comprising:
a chemo attractant compound;
a glutaric acid or its derivative;
a carboxylic acid compound having a chain length from about 5 to about 18 carbons;
a polymer; and
a swelling agent,
wherein at least a portion of the packaging comprises the at least one hydrolytically degradable or compostable polymer and the packaging is for a medical device selected from the group consisting of test tubes, syringes, tubing, catheters, shunts, collection bags, sutures, staplers, endoscopic devices, hernia meshes, monitoring sensors, pulse oximeters, and combinations thereof.

12. The packaging of claim 11, further comprising an additive selected from the group consisting of a microbe which can digest the polymeric material, a compatibilizing additive, a positive chemotaxis agent to attract the microbes, a metal to induce rusting, a colorant, a carrier resin, and combinations thereof.

13. The packaging of claim 11, wherein the packaging includes a clear plastic sheet comprising the hydrolytically degradable or compostable polymer.

14. The packaging of claim 11, wherein the hydrolytically degradable or compostable polymer further comprises a chain extension agent in an effective amount to increase the mechanical strength and processability of the polymer compared to the same polymer formed in the absence of the chain extension agent.

15. The packaging of claim 14, wherein the chain extension agent is a molecule having two or more reactive functional groups selected from the group consisting of isocyanates, epoxides, anhydrides, acid chlorides, esters, aldehydes, and combinations thereof.

16. The packaging of claim 14, wherein the chain extension agent comprises a diisocyanate.

17. The packaging of claim 14, wherein the chain extension agent comprises a vinyl group.

18. The packaging of claim 11, further comprising a non-biodegradable biocompatible polymer.

19. The packaging of claim 11, further comprising a polymer coating.

20. The packaging of claim 19, wherein the polymer coating is selected from the group consisting of biodegradable and slowly biodegradable polymer coatings.
